(19) United States
(12) Patent Application Publication
(10) Pub. No.: US 2014/0358622 A1
(43) Pub. Date: Dec. 4, 2014

(54) WORK STATION ARRANGEMENT SYSTEM AND METHOD

(71) Applicants: Fu Tai Hua Industry (Shenzhen) Co., Ltd., Shenzhen (CN); Hon Hai Precision Industry Co., Ltd., New Taipei (TW)

(72) Inventors: YU-KAI XIONG, Shenzhen (CN); XIN LU, Shenzhen (CN); YU-YONG ZHANG, Shenzhen (CN); XIANG-LIN CHENG, Shenzhen (CN); DONG-SHENG LV, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 14/291,010

(22) Filed: May 30, 2014

(30) Foreign Application Priority Data
Jun. 3, 2013 (CN) 201310215753X

(51) Int. Cl. G06Q 10/06

(52) U.S. Cl. CPC G06Q 10/06315
USPC 705/7.25

(57) ABSTRACT

A system for arranging work stations arranges a number of work stations of different types in a predetermined area, and calculates a number of each type of work station to ensure that a total production efficiency of each type of work station can reach a predetermined production efficiency.

### FIELD

The present disclosure relates to a work station arrangement system and method.

### BACKGROUND

In arranging a number of work stations of different types in a limited space, factors such as productive efficiency of each type of the work station should be considered.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a block diagram of a work station arrangement system in accordance with an exemplary embodiment.

FIG. 2 shows a diagram of a number of work stations in certain locations.

FIG. 3 is a flowchart of a method of arranging work stations implemented by the work station arrangement system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

Embodiments of the present disclosure will be described with reference to the accompanying drawings.

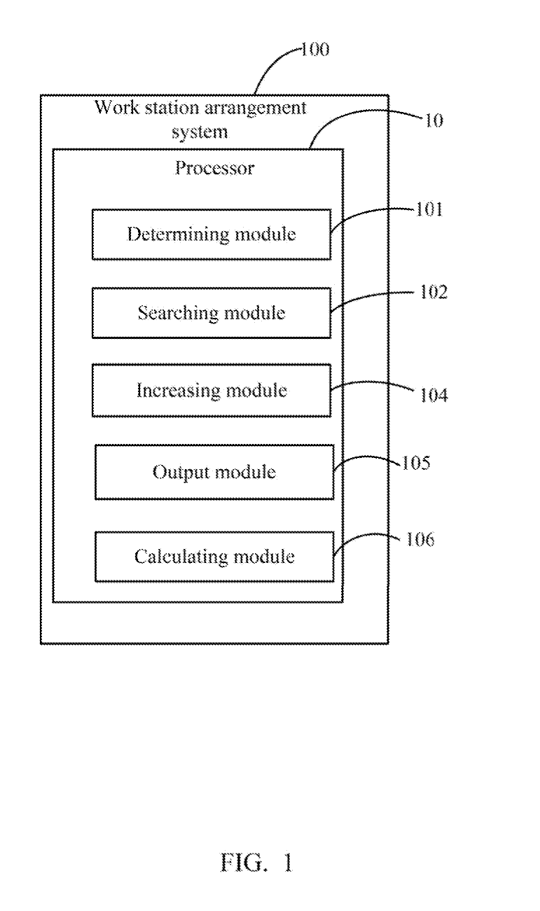

FIG. 1 illustrates a work station arrangement system 100 for arranging a number of work stations of different types in an area of predetermined size (hereinafter “predetermined area”). In the environment of processing, a product must pass through all types of work stations for processing to be completed. Each type of the work station is of a particular type, for the processing of a particular portion of the product or applying a particular process to the product. Each type of work station has individual factors including a production efficiency of the work station, and a working size of the work station (hereinafter “required size,” that is the amount of space required for the operator of the station to carry out his duties) in relation to all the other work stations within the predetermined area. In one embodiment, the production efficiency of the work station is an ability to process a number of products using a fewest resources in a predetermined period of time. In one embodiment, the required size of each type of work station includes a length of the work station and minimum distances in all directions for the operator to carry out his duties.

The work station arrangement system 100 includes a determining module 101, a searching module 102, an increasing module 104, and an output module 105 being a collection of software instructions executed by one or more processors 10.

The determining module 101 determines whether all types of the work stations are allowed to be placed into the predetermined area according to the required sizes of the work stations. The searching module 102 searches for a work station of which the production efficiency is lowest among all the types of the work stations allowed in the predetermined area. The determining module 101 determines whether the production efficiency of the searched work station is less than a predetermined production efficiency of the product. For example, if the predetermined production efficiency of the product is 80%, it is need that the total production efficiency of each type of work station is more than 80%. The increasing module 104 increases the number of the searched work stations until the total production efficiency of the searched work station is not less than the predetermined production efficiency when the production efficiency of the searched work station is less than the predetermined production efficiency. In one embodiment, the total production efficiency of each type of work station is acquired by multiplying the number of the work stations of each type and the production efficiency of each work station. The determining module 101 determines whether the predetermined area can accommodate the increased searched work stations according to the required sizes of the work stations. The determining module 101 determines whether the production efficiencies of all remaining types of the work stations are less than the predetermined production efficiency if there is sufficient room in the predetermined area for all the increased searched work stations. The output module 105 outputs the number of all types of work stations when the production efficiencies of the all remaining types of the work stations are not less than the predetermined production efficiency. The searching module 102 further searches for another type of work station of which the production efficiency is lowest among the all remaining types of work stations when there is at least one type of work station of which the production efficiency is less than the predetermined production efficiency. Based on the results of search, the above processes are repeated until the total production efficiency of each type of work station is not less than the predetermined production efficiency.

The output module 105 can further output information that the increased number of searched work stations cannot be accommodated in the predetermined area if the total of all required sizes is greater than the size of the predetermined area.

The output module 105 can further output information that all types of the work stations cannot be accommodated in the predetermined area if the total of all required sizes is greater than the size of the predetermined area.

The work station arrangement system 100 further includes a calculating module 106 which is included in the collection of software instructions executed by one or more processors 10. The calculating module 106 calculates a distance between every adjacent work station in the predetermined area according to the required size of each work station and the determined number of all types of the work stations when the total production efficiency of each type of work station allowed in the predetermined area is greater than the predetermined production efficiency.

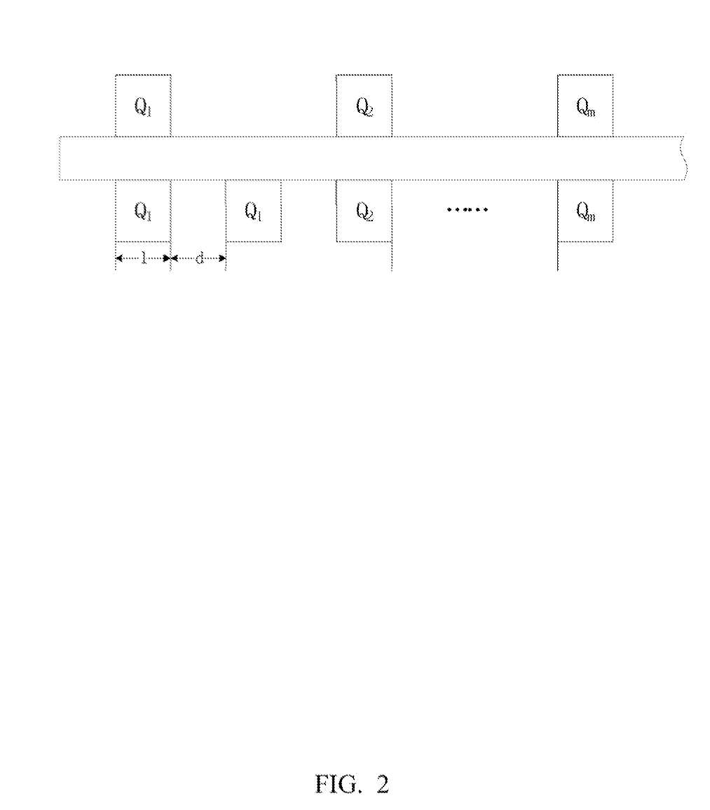

FIG. 2 shows a diagram of a number of work stations. There are a number of work stations of M type, the processing time of each type of work station is presented as Tᵢ, the production efficiency of each type of the work station is presented as 1/Tᵢ (i=1, 2, . . . , M), the minimum distance for each type of the work station is presented as dₘᵢₙ, the predetermined size of the area is presented as L, the predetermined production efficiency is presented as U, the length of each type of work station is presented as l, the number of the work stations of type is presented as Nᵢ (i=1, 2, . . . , M). The formula for calculating Nᵢ is

$$\vert \begin{matrix}min {N}_{1} \\ min {N}_{2} \\ … \\ min {N}_{M} \\ \{ \begin{matrix}min \{ {N}_{1} \frac{1}{{T}_{1}} \times , {N}_{2} \times \frac{1}{{T}_{2}} , … , {N}_{M} \times \frac{1}{{T}_{M}} \} \geq U \\ \frac{L}{{\sum }_{i = 1}^{M} ⌈ \frac{{N}_{i}}{2} ⌉} \geq {d}_{min} \\ {\sum }_{i = 1}^{M} ( ⌈ \frac{{N}_{i}}{2} ⌉ l ) + ( {\sum }_{i = 1}^{M} ⌈ \frac{{N}_{i}}{2} ⌉ - 1 ) \frac{L}{{\sum }_{i = 1}^{M} ⌈ \frac{{N}_{i}}{2} ⌉} \leq L \\ {N}_{i} \geq 0 , {N}_{i} ∈ Z\end{matrix}\end{matrix}$$

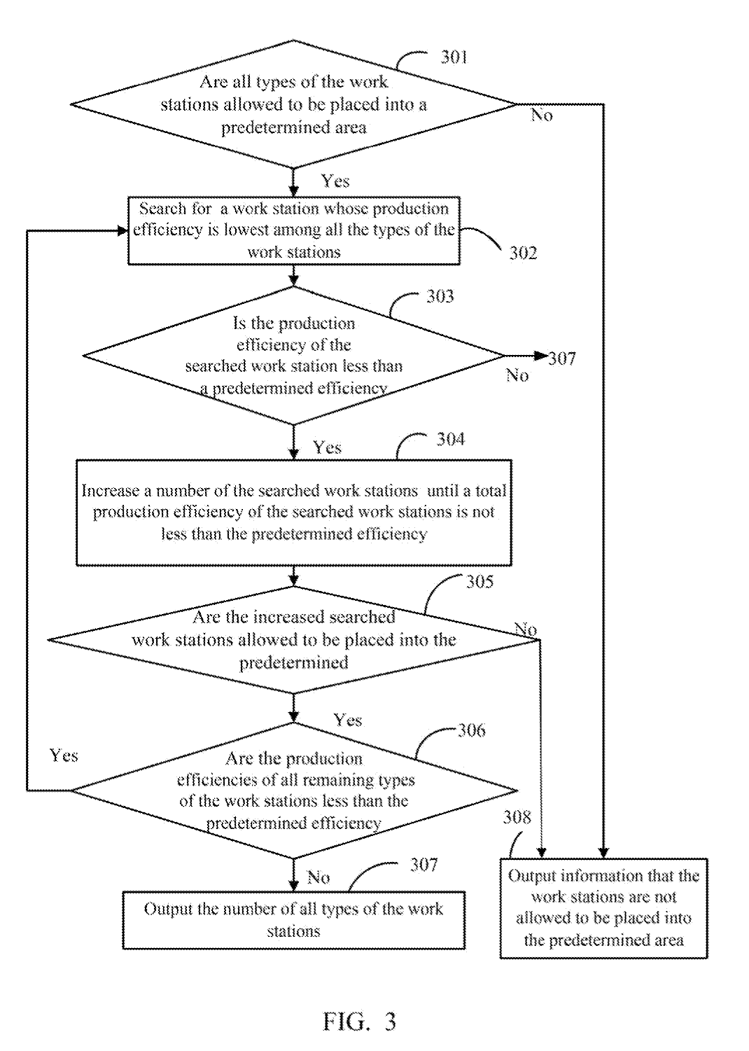

FIG. 3 is a flowchart of a method of arranging work stations implemented by the work station arrangement system of FIG. 1.

In 301, a determining module determines whether all types of work station are allowed to be placed into the predetermined area according to the required size of the work stations, if yes, go to 302, if no, go to 308.

In 302, a searching module searches for work station of which the production efficiency is lowest among all types of work stations allowed in the predetermined area.

In 303, the determining module determines whether the production efficiency of the searched work station is less than a predetermined production efficiency of the product, if yes, go to 304, if no, go to 307.

In 304, an increasing module increases the number of the searched work stations until the total production efficiency of the searched work station is not less than the predetermined production efficiency.

In 305, the determining module determines whether the increased searched work stations can be accommodated in the predetermined area according to the required sizes of the work stations, if yes, go to 306, if no, go to 308.

In 306, the determining module determines whether the production efficiencies of all remaining types of work station are less than the predetermined production efficiency, if yes, go to 302, if no, go to 307.

In 307, an output module outputs the number of all types of work stations.

In 308, the output module outputs information that the work stations cannot be allowed to be placed into the predetermined area.

The method further comprises the following steps: a calculating module calculates a distance between every adjacent work station in the predetermined area according to the required size of each work station and the determined number of all types of work stations when the total production efficiency of each type of work station allowed in the predetermined area is greater than the predetermined production efficiency.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A work station arrangement system for arranging a plurality of work stations with different types in a predetermined area, wherein each type of work station has corresponding factors comprising a production efficiency of the work station, and a required size of the work station, the work station arrangement system comprising:
one or more processors; and
a plurality of modules to be executed by the one or more processors, wherein the plurality of modules comprises:
a searching module configured to search for a type of a work station of which the production efficiency is lowest among all the types of the work stations;
a determining module configured to determine whether the production efficiency of the searched work station is less than a predetermined production efficiency;
an increasing module configured to increase a number of the searched work stations until a total production efficiency of the searched work stations is not less than the predetermined production efficiency when the production efficiency of the searched work station is less than the predetermined production efficiency, wherein, the total production efficiency of each type of work station is acquired by multiplying the number of the work stations of each type and the production efficiency of each work station;
the determining module further configured to determine whether the increased searched work stations are allowed to be placed into the predetermined area according to the required sizes of all types of work stations;
the determining module further configured to determine whether the production efficiencies of all remaining types of the work stations are less than the predetermined production efficiency after the increased searched work stations are allowed to be placed into the predetermined area; and
an output module configured to output the number of all types of work stations when the production efficiencies of the all remaining types of the work stations are not less than the predetermined production efficiency.

2. The work station arrangement system as described in claim 1, wherein the searching module is further configured to search for another type of work station whose production efficiency is lowest among the all remaining types of work stations when there is at least one type of work station whose production efficiency is less than the predetermined production efficiency.

3. The work station arrangement system as described in claim 1, wherein the output module is further configured to output information that the increased number of searched work stations are not allowed to be placed into the predetermined area if a total of all required sizes is greater than the size of the predetermined area.

4. The work station arrangement system as described in claim 1, wherein the determining module is further configured to determine whether all types of the work stations are allowed to be placed into the predetermined area according to the required sizes of the work stations; and the searching module is configured to search for the work station whose production efficiency is lowest among all the types of the work stations allowed in the predetermined area.

5. The work station arrangement system as described in claim 1, wherein the plurality of modules further comprises a calculating module, the calculating module is configured to calculate a distance between every adjacent work station in the predetermined area according to the required sizes of the work stations and the determined number of all types of the work stations when the total production efficiency of each type of work station allowed in the predetermined area is greater than the predetermined production efficiency.

6. A work station arrangement method for arranging a plurality of work stations with different types in a predetermined area, wherein each type of work station has corresponding factors comprising a production efficiency of the work station, and a required size of the work station, the work station arrangement method comprising:
searching for a type of a work station of which the production efficiency is lowest among all the types of the work stations;
determining whether the production efficiency of the searched work station is less than a predetermined production efficiency;
increasing a number of the searched work stations until a total production efficiency of the searched work stations is not less than the predetermined production efficiency when the production efficiency of the searched work station is less than the predetermined production efficiency, wherein, the total production efficiency of each type of work station is acquired by multiplying the number of the work stations of each type and the production efficiency of each work station;
determining whether the increased searched work stations are allowed to be placed into the predetermined area according to the required sizes of all types of work stations;
determining whether the production efficiencies of all remaining types of the work stations are less than the predetermined production efficiency after the increased searched work stations are allowed to be placed into the predetermined area; and
outputting the number of all types of work stations when the production efficiencies of the all remaining types of the work stations are not less than the predetermined production efficiency.

7. The work station arrangement method as described in claim 6, further comprising:
searching for another type of work station whose production efficiency is lowest among the all remaining types of work stations when there is at least one type of work station whose production efficiency is less than the predetermined production efficiency.

8. The work station arrangement method as described in claim 6, further comprising:
outputting information that the increased number of searched work stations are not allowed to be placed into the predetermined area if a total of all required sizes is greater than the size of the predetermined area.

9. The work station arrangement method as described in claim 6, further comprising:
determining whether all types of the work stations are allowed to be placed into the predetermined area according to the required sizes of the work stations; and
searching for the work station whose production efficiency is lowest among all the types of the work stations allowed in the predetermined area.

10. The work station arrangement method as described in claim 6, further comprising:
calculating a distance between every adjacent work station in the predetermined area according to the required sizes of the work stations and the determined number of all types of the work stations when the total production efficiency of each type of work station allowed in the predetermined area is greater than the predetermined production efficiency.
